(19) United States
(12) Patent Application Publication
(10) Pub. No.: US 2005/0142267 A1
(43) Pub. Date: Jun. 30, 2005

(54) Method of cutting cheese

(76) Inventors: Karl Fasshauer, Schkeuditz (DE); Holm Walter Prescher, Leipzig (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/956,345

(22) Filed: Oct. 4, 2004

(30) Foreign Application Priority Data
Oct. 2, 2003 (DE) 103 46 050.0

(51) Int. Cl. B26D 3/00

(52) U.S. Cl. 426/518

(57) ABSTRACT

A method of cutting cheese by means of a cutting tool, includes cooling the cheese before the cutting operation. In preferred embodiments, the cheese is cooled by a cryogenic refrigerant with at least parts of the cheese cooled to below zero degrees centigrade. Cheese slices from the cutting operation are conveyed in a conveyor type freezer where they are subjected to a cryogenic bath and then packaged in a freeze container where they are conveyed and stored until removed and used.

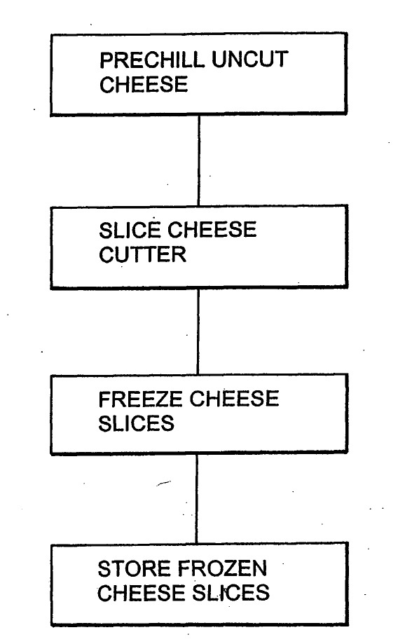

### BACKGROUND AND SUMMARY OF THE INVENTION

This application claims the priority of German Application No. 103 46 050.0 filed Oct. 2, 2003, the disclosure of which is expressly incorporated by reference herein.

The invention relates to a method of cutting cheese by means of a cutting tool.

A number of methods of cutting cheese by means of many different cutting tools (saw blade machines, knife arrangements) are known. All known methods have in common that the cheese tends to adhere to the cutting tool and therefore deform during the cutting operation. This then leads to an unsatisfactory result with respect to the endeavored uniformity of the produced slices and/or with respect to the cutting speed.

It is an object of the present invention to provide an improved method of cutting cheese.

This object is achieved according to certain preferred embodiments of the invention, in that the cheese is cooled before the start of the cutting operation. Preferably at least part of the cheese to be cut is frozen before the cutting operation. This reduces the deformability and the stickiness of the cheese (for example, hard cheese, slicing cheese, semifirm cheese, soft cheese). The cheese can be sliced much more easily and rapidly in the cooled condition. A uniform thickness of the slices is achieved, even at a high cutting speed. Furthermore, the method according to the invention clearly reduces the reject rate during the cutting of cheese.

According to certain preferred embodiments of the invention, the cheese is chilled or cooled before cutting by spraying of a cryogenic refrigerant. According to certain preferred embodiments of the invention, the cryogenic refrigerant is liquid nitrogen or liquid carbon dioxide. The chilling or cooling with the cryogenic refrigerant can be done with and without deep freezing of the cheese according to respective different preferred embodiments of the invention.

According to especially preferred embodiments of the invention, the cheese is preferably frozen. Particularly preferably, the cheese is cooled to such an extent that it has a core temperature which is below zero degrees centigrade. This approach intensifies the above-mentioned advantages considerably.

According to other preferred embodiments of the invention, only the surface of the cheese is cooled to a temperature below zero degrees centigrade. This approach also has the above-mentioned advantages and furthermore requires only a minimum of energy for cooling and freezing.

According to an advantageous further development of preferred embodiments of the invention, the cheese is deep-frozen. Particularly advantageously, the cheese is cooled, particularly deep-frozen, by means of a cryogenic refrigerating agent. In particular, the cheese is deep-frozen by means of a cryogenic refrigerating agent, such as intensely cold nitrogen, liquid carbon dioxide, liquid air or generally intensely cold gases and gases liquefied in an intensely cold manner. In the case of these embodiments, the additional special advantage is the efficient and rapid cooling of the cheese, which minimizes the time required for the freezing operation. These embodiments are therefore preferred with a view to increasing the speed of the production of cheese slices.

The following types of cheese (can be processed utilizing the new method according to preferred embodiments of the invention: Emmentaler, Tilsiter, Edamer, Gouda, Räucherkäse, Butterkäse, Camembert, Brie, Ziegenkäse and Mozzarella.

The level of cooling/freezing of the cheese before the cutting is dependent on the cutting technique. For cutting/slicing, the cooling/freezing of blocks or rolls of cheese preferably bring the outer edge of the cheese block or roll to a temperature of −2° C. to −0° C. and the central core of the cheese block or roll to a temperature of ±0° C. to +2° C.

During the slicing of the cheese which has been cooled/frozen according to the invention, results are improved as compared to slicing without precooling/freezing in that the slicing speed is faster, the cheese slices are more uniform, and the cheese slices are optically better as there are no or minimal stringy portions on the edge of the slices.

The single drawing FIGURE schematically depicts sequential steps for processing cheese according toe certain preferred embodiments of the invention.

Referring the drawing FIGURE, the cheese is processed sequentially as illustrated.

Following slicing, the cheese slices are preferably immediately subjected to a short duration deep freezing process. In particular preferred embodiments, the cheese slices are fed from a slicer to a plate band conveyor type froster with an integrated liquid nitrogen bath. In a preferred method, the cheese slices travel in the froster for about 70 seconds as they are subjected to a temperature −140° C. The cheese slices then have a temperature of −20° C. or colder. The freezing of the slices prevents them from sticking together as they are maintained in a freezer or deep freezer and packaged for delivery to hospitals, retirement homes, caterers, airlines and the like. Subsequently the cheese slices are individually, or in small packages, removed from the freeze/deep freeze container for use, with unused slices or packages remaining in the deep freeze container.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Method of cutting cheese, comprising:
cooling the cheese to a predetermined low temperature in a freezing operation, and cutting the cooled cheese.

2. Method according to claim 1, wherein at least portions of the cheese is frozen before the start of the cutting operation.

3. Method according to claim 1, wherein the cheese is cooled to such an extent that it has a core temperature below zero degrees centigrade before the cutting operation.

4. Method according to claim 2, wherein the cheese is cooled to such an extent that it has a core temperature below zero degrees centigrade before the cutting operation.

5. Method according to claim 1, wherein only the surface of the cheese is cooled to a temperature of below zero degrees centigrade before the cutting operation.

6. Method according to claim 1, wherein the cheese is deep-frozen before the start of the cutting operation.

7. Method according to claim 1, wherein the cheese is deep-frozen by means of a cryogenic refrigerant before the start of the cutting operation.

8. Method according to claim 2, wherein the cheese is deep-frozen by means of a cryogenic refrigerant before the start of the cutting operation.

9. Method according to claim 3, wherein the cheese is deep-frozen by means of a cryogenic refrigerant before the start of the cutting operation.

10. Method according to claim 5, wherein the cheese is deep-frozen by means of a cryogenic refrigerant before the start of the cutting operation.

11. Method according to claim 6, wherein the cheese is deep-frozen by means of a cryogenic refrigerant before the start of the cutting operation.

12. Method according to claim 1, wherein the cheese is cooled to the predetermined temperature by means of a cryogenic refrigerant before the start of the cutting operation.

13. Method according to claim 12, wherein the cheese is deep frozen by means of the cryogenic refrigerant.

14. Method according to claim 12, wherein the cryogenic refrigerant is liquid nitrogen.

15. Method according to claim 13, wherein the cryogenic refrigerant is liquid nitrogen.

16. Method according to claim 12, wherein the cryogenic refrigerant is liquid carbon dioxide.

17. Method according to claim 13, wherein the cryogenic refrigerant is liquid carbon dioxide.

18. Method of processing cheese comprising the following sequential steps:
chilling the cheese,
cutting the chilled cheese into chilled cheese slices,
feeding the chilled cheese slices through a freezer while subjecting the cheese slices to a cryogenic bath to form frozen cheese slices, and
packing the frozen cheese slices in a freezing container.

19. Method according to claim 18, wherein the chilling utilizes a cryogenic fluid to chill the cheese.

20. Method according to claim 18, wherein the cutting includes slicing the cheese in a high speed slicing operation and immediately thereafter feeding the cheese slices to the freezer.

21. Method according to claim 20, wherein the cryogenic bath subjects the cheese slices to a temperature colder than
−100° C. for a period of time sufficient to freeze the cheese slices to a temperature of −20° C. or colder.

22. Method according to claim 20, comprising removing a portion of the frozen cheese slices from the freezing container while retaining remaining cheese slices frozen in the cheese container.
